(19) United States
(12) Patent Application Publication
(10) Pub. No.: US 2004/0238005 A1
(43) Pub. Date: Dec. 2, 2004

(54) Method of judging end of cleaning treatment and device for the cleaning treatment

(76) Inventor: Kazuhisa Takayama, Tokyo (JP)

Correspondence Address: TAKEUCHI & TAKEUCHI, Suite 310, 1700 Diagonal Road, Alexandria, VA, 22314, US

(21) Appl. No.: 10/854,672

(22) Filed: May 27, 2004

(30) Foreign Application Priority Data
May 29, 2003 (JP) 2003-151890

(51) Int. Cl. B08B 7/04

(52) U.S. Cl. 134/18; 134/56 R; 134/2

(57) ABSTRACT

A cleaning device (10) used in a cleaning treatment, in which deposits adhering to an object to be cleaned are removed by a recycled cleaning liquid, comprises a first sensor (11) generating a first signal representing a cleanness of the cleaning liquid before use in the cleaning treatment, a second sensor (13) generating a second signal representing a cleanness of the cleaning liquid after use in he cleaning treatment, and a cleaning-end-judgement section (20) acquiring a difference between the first and second signals to judge that the cleaning treatment has been completed when the acquired difference is equal to or smaller than a predetermined threshold value.

### BACKGROUND OF THE INVENTION

1. Field of the Invention

The present invention relates to a cleaning treatment for cleaning deposits formed on a semiconductor device, especially a method of judging the completion (end) of the cleaning treatment and a cleaning device.

2. Description of the Related Art

Several patent documents disclose a method of cleaning deposits, which are formed on a semiconductor device, such as a semiconductor circuit and a liquid crystal circuit, (hereinafter “object to be cleaned”) in an etching process using a resist for patterning and ashing process.

For example, Japanese Patent Application Kokai Number 6-168929 discloses that the concentration of a gas, which is produced when the object to be cleaned is cleaned with a cleaning liquid, is measured and compared with predetermined value to judge the completion of the cleaning treatment. Japanese Patent Application Kokai Numbers 10-321589 discloses that the number of particles of deposits, which are produced when the object to be cleaned is cleaned with a circulated cleaning liquid, is counted and compared with a predetermined value to judge the completion of the cleaning treatment. Japanese Patent Application Kokai Numbers 8-236494 discloses that the concentration of hydrogen peroxide, which is produced when the object to be cleaned is cleaned with a cleaning gas, is measured and compared with a predetermined value to judge the completion of the cleaning treatment.

In the above-described methods of judging the completion of the cleaning treatment, the measured value is compared with a predetermined value which is a reference value for ending the cleaning. However, it is necessary to decide the reference value based upon various conditions, such as, for example, quantity and ingredient of the deposits, ingredient and temperature of the cleaning liquid, and number of the object to be cleaned cleaned in a lump. Accordingly, it has been required that a number of experiments are repeated in accordance with various different conditions using a number of samples to find the reference values for judging the completion of the cleaning treatment.

### SUMMARY OF THE INVENTION

Accordingly, it is an object of the present invention to provide a method of judging the completion of the cleaning treatment without the repeated experiments and a cleaning device using the method of judging completion of the cleaning treatment.

In order to achieve the above object, according to an aspect of the present invention, a method of judging an end of a cleaning treatment for removing deposits adhering to an object to be cleaned using a recycled cleaning liquid comprises the steps of acquiring a difference between a contamination condition of the recycled cleaning liquid before the cleaning treatment and a contamination condition of the recycled cleaning liquid after the cleaning treatment, and concluding that the cleaning treatment has been completed when the acquired difference is equal to or smaller than a predetermined threshold value or when the acquired difference does not indicate any change.

According to another aspect of the present invention, a cleaning device used in a cleaning treatment, in which deposits adhering to an object to be cleaned are removed by a cleaning liquid of recycle (hereinafter “recycled cleaning liquid”) comprises a first sensor generating a first signal representing a contamination condition of the recycled cleaning liquid before the cleaning treatment, a second sensor generating a second signal representing a contamination condition of the recycled cleaning liquid after the cleaning treatment, and a cleaning-end-judgement section acquiring a difference between the first and second signals and concluding that the cleaning treatment has been completed when the acquired difference is equal to or smaller than a predetermined threshold value or when said acquired difference does not indicate any change.

The contamination condition is any of a quantity of residues contained in the cleaning liquid, a pH value of the cleaning liquid, and a component ratio of the cleaning liquid.

The cleaning device further comprises a measuring unit including the first and second sensors and an optical-source-sharing section for sharing an optical source to the first and second sensors, wherein each of the first and second sensors generates the signal representing the contamination condition according to a strength of light from the optical source.

Alternatively, the measuring unit may include, instead of the optical-source-sharing section, an optical-source-distributing section for equally distributing an optical source to the first and second sensors.

### BRIEF DESCRIPTION OF THE DRAWINGS

FIG. 1 a block diagram of a cleaning device according to the first embodiment of the present invention.

FIG. 2 is a flow chart of an operation of an end-judgement section.

FIG. 3(a) is a graph showing a strength of a signal outputted from a first sensor.

FIG. 3(b) is a graph showing a strength of a signal outputted from a second sensor.

FIG. 3(c) is a graph showing a time-varying change of a difference between the signal strength.

FIG. 4 a block diagram of a cleaning device according to the second embodiment of the present invention.

FIG. 5 is a block diagram of a measuring apparatus according to the fourth embodiment of the present invention.

FIG. 6 is a block diagram of a measuring apparatus according to the fifth embodiment of the present invention.

FIG. 7 is a graph showing a time-differential calculus of the change of the difference between the signal strengths.

FIG. 8(a) is a graph showing a strength of a signal outputted from the first sensor, wherein the signal strength increases according to a change for the worse of a contamination condition.

FIG. 8(b) is a graph showing a strength of a signal outputted from the second sensor, wherein the signal strength increases according to a change for the worse of a contamination condition.

FIG. 8(c) is a graph showing a time-varying change of the differences between the signal strengths, wherein the signal strengths increase according to a change for the worse of the contamination condition.

### DESCRIPTION OF THE PREFERRED EMBODIMENTS

(First Embodiment)

Embodiments of the present invention will now be described with reference to the accompanying drawings.

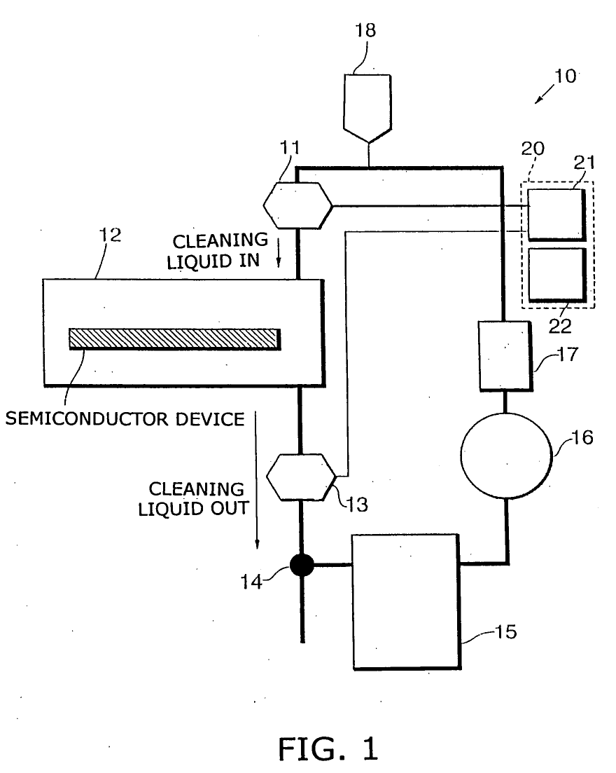

In FIG. 1, a cleaning device 10 according to the present invention comprises a first sensor 11 for measuring the quantity of particles contained in a cleaning liquid circulating for recycle, a cleaning vessel 12 for cleaning a semiconductor device or an object to be cleaned with the cleaning liquid of which particles are measured, a second sensor 13 for measuring the quantity of particles contained in the cleaning liquid outputted from the cleaning vessel 12, a three way valve 14 for disposing or circulating (for recycle) the cleaning liquid of which particles are measured by the second sensor, a tank 15 for storing the cleaning liquid circulated for recycle by the three way valve 14, a pump 16 for press-sending the cleaning-liquid in the tank 15, a filter 17 for filtering particles contained in the cleaning liquid press-sent by the pump 16, and a cleaning liquid supplying tank 18 for storing a new cleaning liquid to dilute particles contained in the cleaning liquid filtered by the filter 17. The above elements are connected to each other by circulating pipes.

The cleaning device 10 further comprises an end-judgement section 20 for judging the completion of the cleaning treatment according to signals outputted from the first and second sensors 11 and 13, respectively.

For example, trade name “ST-106” (made by Tokyo Ohka Industry Co., Ltd.) is used as the cleaning liquid. If a temperature adjustment section for adjusting the temperature of the cleaning liquid is provided in the cleaning device 10, the cleaning efficiency increases.

The first and second sensors 11 and 13 measure the quantity of the particles contained in a predetermined amount of the cleaning liquid and output an electrical signal according to the measured quantity. For example, as the quantity of the particles contained in the cleaning liquid, the level (strength) of the outputted signal.

The cleaning vessel 12 accommodates semiconductor devices to be cleaned. The number of the semiconductor devices accommodated in the cleaning vessel 12 may be single or plural, and a part or whole of the semiconductor devices are dipped in the cleaning liquid. If a circulating section for circulating the cleaning liquid in the cleaning vessel 12 is provided in the cleaning vessel 12, the cleaning efficiency increases. Also, if a shaking section for shaking the semiconductor devices in the cleaning vessel 12 is provided in the cleaning vessel 12, the cleaning efficiency increases. The cleaning vessel 12 is not limited to a bath type for dipping the semiconductor devices in the cleaning liquid but it may be spray type for spraying the cleaning liquid onto the semiconductor devices.

The filter 17 filters deposits, which are removed from the semiconductor device during the cleaning treatment with the cleaning liquid, such as resist pieces used for patterning and substance pieces produced in the ashing process. Fine pieces which cannot be filtered by the filter 17 are contained in the recycled cleaning liquid as the particle and the signal for representing the quantity of the fine particles is outputted from the first and second sensors 11 and 13.

The cleaning liquid supplying tank 18 stores a flesh cleaning liquid and supplies it to the cleaning liquid containing the fine particles to reduce the quantity of the particles per a unit amount, thus improving the quality of the cleaning liquid contaminated by the particles.

The tank 15, the pump 16, the filter 16, and the cleaning liquid supplying tank 18 may be disposed anywhere in the pipes for the recycle except for the place between the first sensor 11, which counts the number of the particles in the cleaning liquid, and the second sensor 13, which counts the number of the particles of the cleaning liquid cleaned in the cleaning vessel 12.

The end-judgement section 20 comprises a comparing section 21 for finding the difference of the strengths of the signals outputted from the first and second sensors 11 and 13 and a judgment section 22 for judging the completion of the cleaning treatment (concluding that the cleaning treatment has been completed) when the difference of the signal strengths found by the comparing section 21 is less than a predetermined threshold value.

The operation of the cleaning device 10 will be described.

The recycled cleaning liquid stored in the tank 15 is press-sent by the pump 16 through the filter 17. The fresh cleaning liquid stored in the cleaning liquid supplying tank 18 is supplied to the recycled cleaning liquid so as to dilute the concentration of the particles contained in a unit amount, thus improving the quality of the recycled cleaning liquid. The first sensor 11 outputs a signal representing the quantity of the particles in the recycled cleaning liquid (signal of which strength reduces as the quantity of the particles increases) to the end-judgement section 20. The cleaning liquid, after passing through the first sensor 11, enters the cleaning vessel 12 in which semiconductor devices or the object to be cleaned is accommodated. When the semiconductor devices in the cleaning vessel 12 are exposed to the cleaning liquid, the deposits clinging to the semiconductor devices are separated from the semiconductor devices to become new particles in the cleaning liquid. The cleaning liquid is outputted from the outlet of the cleaning vessel 12 to the three way valve 14 through the second sensor 13. The cleaning liquid is sent to a liquid waste disposer (not shown) or the tank 15 for recycle by the control of the three way valve 14.

The second sensor 13 outputs a signal representing the quantity of the particles contained in the cleaning liquid discharged from the cleaning vessel 12 (signal of which strength reduces as the quantity of the particles increases) to the end-judgement section 20.

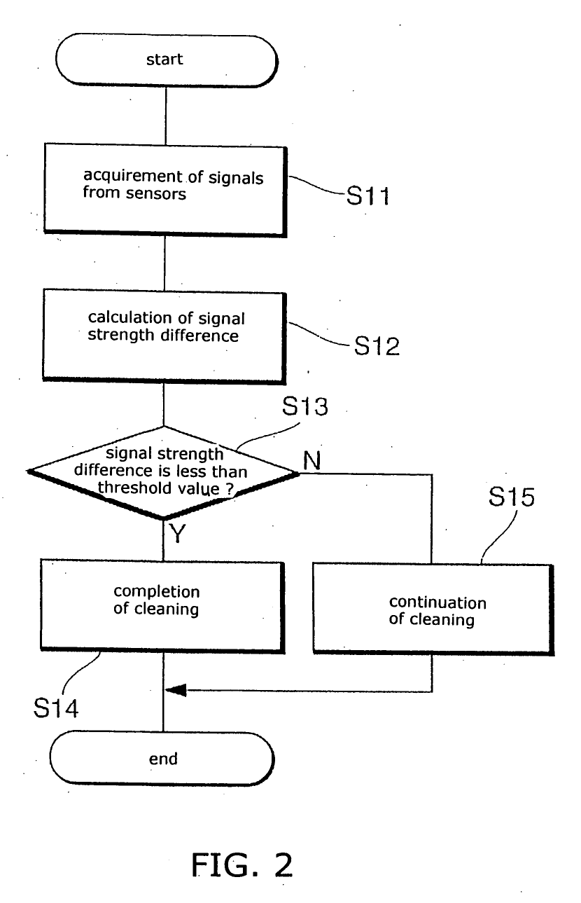

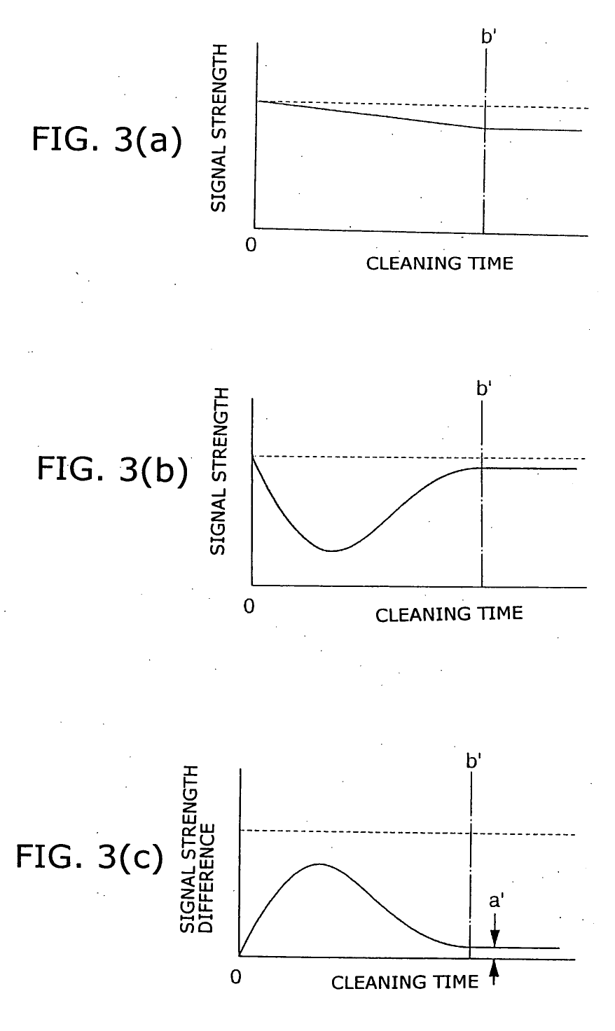

The operation of the end-judgement section 20 will be described with reference to FIGS. 2 and 3.

The end-judgement section 20 receives the signals from the first and second sensors 11 and 13 (Step S11). As shown in FIG. 3(a) showing the strength of the signal from the first sensor 11, the strength of the signal of the recycled cleaning liquid reduces gradually as the cleaning time elapses and then remains at a constant level after a certain cleaning time.

By contrast, as shown in FIG. 3(b) showing the strength of the signal from the second sensor 13, the strength of the signal reduces more rapidly than the that of the first sensor 11. That is because the signal from the first sensor 11 represents the quantity of the particles in the cleaning liquid after filtered by the filter 17 and diluted by the fresh cleaning liquid, while the signal from the second sensor 13 represents the quantity of the particles in the cleaning liquid immediately after the cleaning of the object to be cleaned. As shown in FIG. 3(b), the strength of the signal increases gradually after the rapid reduction. That is because the quantity of the particles becomes smaller gradually for the reason that although the deposits of the semiconductor devices are separated into the particles in the cleaning liquid, the cleaning liquid is filtered and diluted to reduce the particles. Thus, it shows that the cleanness of the cleaning liquid has been improved. When the contamination condition has been improved up to a predetermined level, the dilution by the fresh cleaning liquid is stopped. The cleaning continues with the cleaning liquid containing fine particles not filtered by the filter 17. At this point, if the deposits have been already removed from the semiconductor devices, the contamination condition or cleanness remains unchanged even if the cleaning liquid is recycled because no particle is produced any more. Accordingly, the quantity of the particles in a unit amount becomes constant and the strength of the signal from the second sensor 13 becomes constant.

The received signals are sent to the comparing section 21 of the end-judgement section 20 so that the comparing section 21 calculates the difference of the strengths of the signals from the first and second sensors 11 and 13 (Step S12). The calculation result is shown in FIG. 3(c).

The calculated difference value of the signal strengths is sent to the judgement section 22 so as to compare it with a predetermined threshold value a′ shown in FIG. 3(c) and judge if the difference value is equal to or smaller than the threshold value a′ (Step S13). When the difference value is equal to or smaller than the threshold value a′, the judgement section 22 judges the completion of the cleaning treatment at a time b′ shown in FIG. 3(c) (Step 14). When the difference value is larger than the threshold value a′, the judgement section 22 judges the continuation of the cleaning treatment (Step 14).

The result of the judgement by the judgement section 22 is sent to a control section (not shown) so that the control section performs either the continuation or completion of the cleaning-treatment according to the judgement result.

According to the cleaning device 10 of the present invention, the quantity of the particles contained in the cleaning liquid is measured before and after the cleaning of the semiconductor devices with the cleaning liquid to obtain the difference between the signal strengths representing the measured quantity of the particles. When the difference value is smaller than the predetermined threshold value, it is judged that the cleaning treatment has been completed. Accordingly, any experiment to decide the end of the cleaning treatment, which requires sampling of various cleaning liquids having different ingredients and temperatures, becomes unnecessary, thereby enabling the cost saving and increasing the efficiency.

(Second Embodiment)

In the first embodiment, the end judgement is performed by using the threshold value. A cleaning device 30 according to the second embodiment performs the end judgement without using the threshold value.

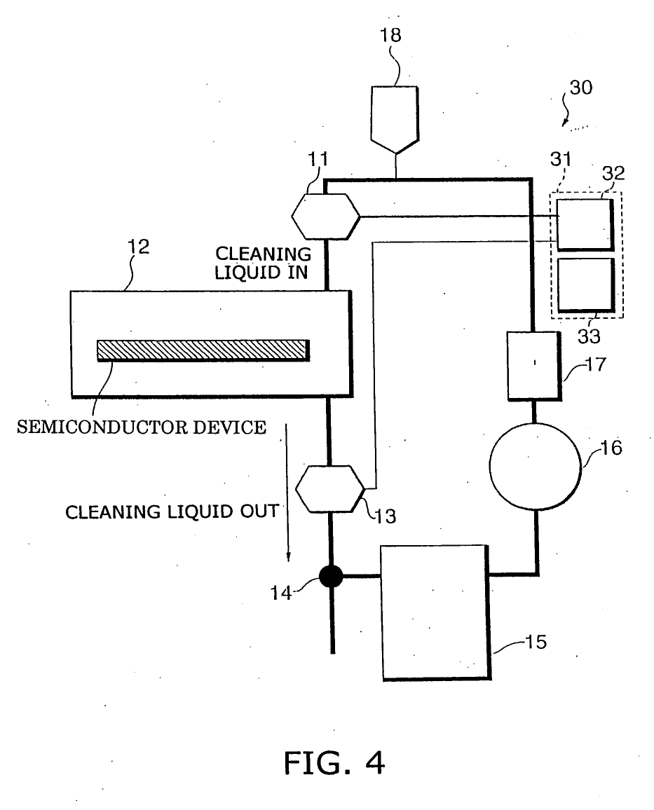

In FIG. 4, the cleaning device 30 comprises, like the cleaning device 10 of the first embodiment, the first sensor 11, the cleaning vessel 12, the second sensor 13, the three way valve 14, the tank 15, the pump 16, the filter 17, the cleaning liquid supplying tank 18, and a end-judgement section 31 instead of the end-judgement section 20. The above elements of the second embodiment are same as those of the first embodiment except for the end-judgment section 31 and, therefore, the description of the same elements is omitted.

The end-judgement section 31 comprises a comparing section 32 for calculating the difference of the signal strengths between the first and second sensors 11 and 13 and a judgement section 33 for judging the completion of the cleaning treatment when the difference value calculated by the comparing section 32.

The comparing section 32 functions the same as the comparing section 21 of the first embodiment. That is, the comparing section 32 calculates the difference between the signal strength of the first sensor 11 shown in FIG. 3(a) and that of the second sensor 13 shown in FIG. 3(b), and outputs the calculation result shown in FIG. 3(c) to the judgement section 33.

The judgement section 33 finds a time-varying change of the difference sent from the comparing section 32. That is, the change amount dD1 of the difference of the signal strength during the period of time ΔT is expressed as follows:

dD1=(D2−D1)/(ΔT)

wherein D1 is the difference of the signal strength at a predetermined time T1 and D2 is the difference of the signal strength after ΔT passed from the time T1.

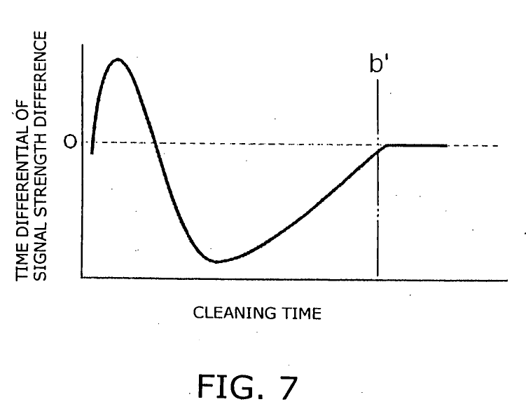

If dD1 is large, it means that the time-varying change of the difference of the signal strengths during the period of time ΔT is large, and if dD1 is small, it means that the time-varying change during the period of time ΔT is small. When dD1 is equal to 0, that is, when there is no change in the difference between the signal strengths, the judgement section judges that the cleaning treatment has been finished. Namely, the difference between the signal strength outputted from the first sensor 11 and the signal strength outputted from the second sensor 13 does not change (corresponding to a time b′ in FIG. 7), it is judged that the cleaning treatment has been completed.

According to the cleaning device 30 of the second embodiment, the signals representing the quantity of the particles contained in the cleaning liquid are measured before and after the cleaning of semiconductor devices with the cleaning liquid to find the difference of the signal strengths. When the difference value does not change, it is judged that the cleaning treatment has been completed. Accordingly, any experiment to decide the end of the cleaning treatment, which requires sampling of various cleaning liquids having different quantities and ingredients of the deposits, different ingredients and temperatures of the cleaning liquid, and different quantities of the object to be cleaned, becomes unnecessary, thereby enabling the cost saving and increasing the efficiency.

(Third Embodiment)

In the first embodiment, the first and second sensors 11 and 13 output the signals representing the quantity of the particles contained in a unit amount of the cleaning liquid. Alternatively, however, a sensor, which outputs a signal representing the concentration of aqua hydrogen peroxide in the cleaning liquid or pH value, may be provided.

For example, when the deposits formed on the semiconductor devices are iron and the cleaning liquid is nitric acid, iron reacts with nitric acid with the following reaction formula:

Fe30 H₂SO₄(2H⁺+SO₄⁻² in the liquid)→FeSO₄+H₂

That is, when iron reacts with hydrogen peroxide, hydrogen is produced and the concentration of H⁺ in the liquid (pH) reduces.

Accordingly, if the difference value between the signal strength representing pH value before the cleaning and that after the cleaning is smaller than a predetermined threshold value or does not change, it is judged that the cleaning treatment has been completed. Accordingly, any experiment to decide the end of the cleaning treatment, which requires sampling of various cleaning liquids, becomes unnecessary, thereby enabling the cost and time saving and increasing the efficiency.

(Fourth Embodiment)

Instead of judging the completion of the cleaning treatment according to the signals representing the pH value, it may be judged according to signals representing the component of the cleaning liquid. A sensor for detecting the component of the cleaning liquid is disclosed in Japanese Patent Application Kokai Number 6-331541. The sensor calculates the absorbances of lights of respective wave lengths from the signal strength of transmitted light from a optical source, which illuminates the cleaning liquid. The sensor, then, detects the component of the cleaning liquid according to the calculated absorbances of lights and the analytical curve, which has been determined beforehand by the high volume analytic method. A cleaning device according to the fourth embodiment comprises a measuring unit 40, in which the first sensor for detecting the component of the cleaning liquid before the cleaning and the second sensor for detecting the component of the cleaning liquid after the cleaning use a common optical source. The construction of the fourth embodiment is the same as that of the above-described embodiments except for the measuring unit 40 and, therefore, only the measuring unit 40 will be described with reference to the block diagram.

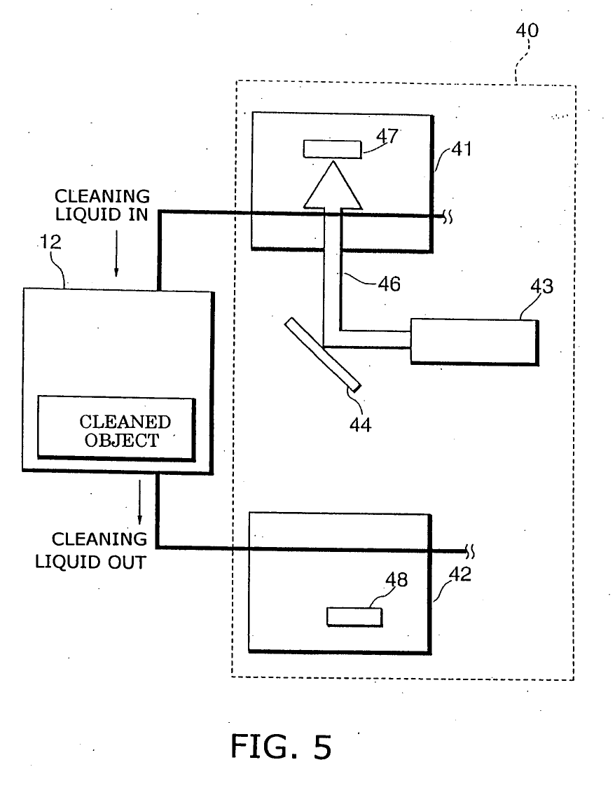

In FIG. 5, the measuring unit 40 comprises a first sensor 41, a second sensor 42, a optical source section 43 for generating a optical source supplied to the respective sensors 41 and 42, and a optical source sharing section 44 for commonly using the optical source of the optical source section 43 for the first and second sensors 41 and 42. An optical path 46 from the optical source of the optical source section 43 is formed by a prism, a mirror, an optical fiber, and so fourth so that light from the optical source section 43 passes through the optical path and is targeted on a photosensitive section 47 or 48 provided on the sensor 41 or 42.

The photosensitive section 47 and 48 measure the absorbance of the optical source transmitting the cleaning liquid and output the measured value to a calculation section (not shown). The calculation section calculates according to the measured value and outputs the calculated result to the end-judgement section as a signal representing the component of the cleaning liquid.

The optical source sharing section 44 has functions, for example, to adjust the reflection angle of light using a mirror or a prism, which can control the optical path, and to change the direction of the outlet of the optical fiber so that light from the optical source section 43 or the optical path is selectively switched to enter either the photosensitive section 47 of the second sensor 41 or the photosensitive section 48 of the second sensor 42. As described above, the optical path is selectively changed to direct to either the photosensitive section 47 of the second sensor 41 or the photosensitive section 48 of the second sensor 42, it is not necessary to provide the optical source for each sensor, thus simplifying the measuring unit 40.

Also, since the first and second sensors 41 and 42 share the common optical source for measurement, it is not necessary to correct the difference of the light strengths caused by different optical sources. Accordingly, the difference of the component of the cleaning liquid before and after the cleaning treatment can be measured accurately.

As described above, the cleaning device comprises the measuring unit having the optical source sharing section 44 for sharing the common optical source for the first and second sensors 41 and 42 so as to accurately measure the difference of the component of the cleaning liquid before and after the cleaning treatment. Consequently, the completion of the cleaning treatment can be judged accurately according to the measured result.

(Fifth Embodiment)

Now will be described a measuring unit 50 having, instead of the optical source sharing section 44, a optical source distributing section 51, which distributes the optical source equally.

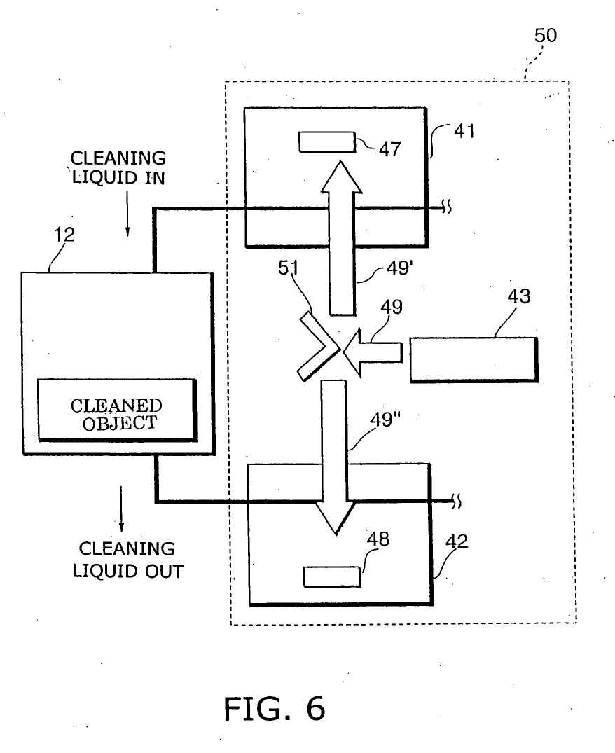

In FIG. 6, the measuring unit 50 comprises the first and second sensors 41 and 42, the optical source section 43 for generating a optical source supplied the respective sensors 41 and 42, and the optical source distributing section 51 for the optical source of the optical source section 43 to the first and second sensors 41 and 42.

The optical source distributing section 44 comprises, for example, a prism for distributing light, which travels in the optical fiber, and a mirror for changing the optical path of the distributed light, which has been illuminated to and distributed by a semi-transmitted prism so that an optical path 49 of optical source of the optical source section 43 is distributed to the photosensitive section 47 of the first sensor 41 and the photosensitive section 48 of the second sensor 42.

As shown in FIG. 6, the optical source distributing section 51 is provided on the optical path 49 of the optical source of the optical source section 43 to distribute the optical source equally and orient a distributed optical path 49′ to the photosensitive section 47 of the first sensor 41 and another distributed optical path 49″ to the photosensitive section 48 of the second sensor 42.

As described above, it is not necessary to provide the optical source for each sensor, thus simplifying the measuring unit 50. Also, it is not necessary to correct the difference of the light strengths caused by different optical sources so that the difference of the component of the cleaning liquid before and after the cleaning treatment. In addition, since light from optical source is distributed continuously to the respective sensors 41 and 42, the measurement of the component of the cleaning liquid is continuously performed.

As described above, the cleaning device comprises the measuring unit having the optical source distributing section 51 for distributing the optical source equally to the first and second sensors 41 and 42 so as to measure the difference of the component of the cleaning liquid before and after the cleaning treatment accurately and continuously. Consequently, the completion of the cleaning treatment can be judged accurately and rapidly according to the measured result.

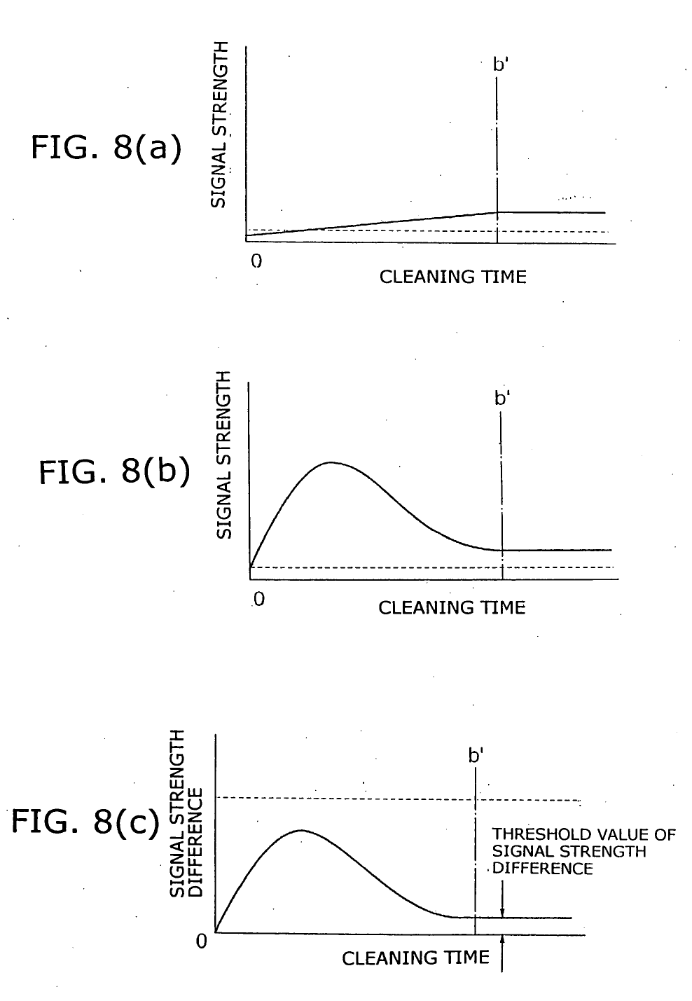

In the above embodiments, as shown in FIGS. 3(a) and 3(b), it is exampled that the signal strengths outputted from the respective sensors reduce as the contamination of the cleaning liquid gets worse. As shown in FIGS. 8(a) and 8(b), however, the signal strengths may increase as the contamination of the cleaning liquid gets worse so that the comparing section of the end-judgement section finds the difference of the signal strengths, which increase as the contamination gets worse.

According to the cleaning device of the present invention, when the difference between the signal strength representing the contamination degree (cleanness) of the cleaning liquid before the cleaning treatment and that after the cleaning treatment is smaller than a predetermined threshold value or does not change, it is judged that the cleaning treatment has been completed. Accordingly, any experiment to decide the end of the cleaning treatment, which requires a large number of samplings of various cleaning liquids having various different conditions, is unnecessary, thus saving the cost and time required for the experiment and increasing the working efficiency.

1. A method of judging an end of a cleaning treatment for removing deposits adhering to an object to be cleaned using a recycled cleaning liquid, said method comprising the steps of:
acquiring a difference between a cleanness of said cleaning liquid before use in said cleaning treatment and a cleanness of said cleaning liquid after use in said cleaning treatment; and
judging that said cleaning treatment has been completed when said acquired difference is equal to or smaller than a predetermined threshold value.

2. A method of judging an end of a cleaning treatment for removing deposits adhering to an object to be cleaned using a recycled cleaning liquid, said method comprising the steps of:
acquiring a difference between a cleanness of said cleaning liquid before use in said cleaning treatment and a cleanness of said cleaning liquid after use in said cleaning treatment; and
judging that said cleaning treatment has been completed when said acquired difference does not indicate any change.

3. The method according to claim 1, wherein said cleanness is a quantity of residues contained in said cleaning liquid.

4. The method according to claim 2, wherein said cleanness is a quantity of residues contained in said cleaning liquid.

5. The method according to claim 1, wherein said cleanness is a pH value of said cleaning liquid.

6. The method according to claim 2, wherein said cleanness is a pH value of said cleaning liquid.

7. The method according to claim 1, wherein said cleanness is a ratio of components contained in said cleaning liquid.

8. The method according to claim 2, wherein said cleanness is a ratio of components contained in said cleaning liquid.

9. A cleaning device used in a cleaning treatment, in which deposits adhering to an object to be cleaned are removed by a recycled cleaning liquid, said cleaning device comprising:
a first sensor generating a first signal representing a cleanness of said cleaning liquid before use in said cleaning treatment;
a second sensor generating a second signal representing a cleanness of said cleaning liquid after use in said cleaning treatment; and
a cleaning-end-judgement section acquiring a difference between said first and second signals to judge that said cleaning treatment has been completed when said acquired difference is equal to or smaller than a predetermined threshold value.

10. A cleaning device used in a cleaning treatment, in which deposits adhering to an object to be cleaned are removed by a recycled cleaning liquid, said cleaning device comprising:
a first sensor generating a first signal representing a cleanness of said cleaning liquid before use in said cleaning treatment;
a second sensor generating a second signal representing a cleanness of said cleaning liquid after use in said cleaning treatment; and
a cleaning-end-judgement section acquiring a difference between said first and second signals to judge that said cleaning treatment has been completed when said acquired difference does not indicate any change.

11. The cleaning device according to claim 9, wherein said cleanness is a quantity of residues contained in said cleaning liquid.

12. The cleaning device according to claim 10, wherein said cleanness is a quantity of residues contained in said cleaning liquid.

13. The cleaning device according to claim 9, wherein said cleanness is a pH value of said cleaning liquid.

14. The cleaning device according to claim 10, wherein said cleanness is a pH value of said cleaning liquid.

15. The cleaning device according to claim 9, wherein said cleanness is a ratio of components contained in said cleaning liquid.

16. The cleaning device according to claim 10, wherein said cleanness is a ratio of components contained in said cleaning liquid.

17. The cleaning device according to claim 9, which further comprises a measuring unit including said first and second sensors and an optical-source-sharing section for sharing an optical source to said first and second sensors, wherein each of said first and second sensors generates said signal representing said cleanness according to a strength of light from said optical source.

18. The cleaning device according to claim 10, which further comprises a measuring unit including said first and second sensors and an optical-source-sharing section for sharing an optical source to said first and second sensors, wherein each of said first and second sensors generates said signal representing said cleanness according to a strength of light from said optical source.

19. The cleaning device according to claim 9, which further comprises a measuring unit including said first and second sensors and an optical-source-distributing section for equally distributing an optical source to said first and second sensors, wherein each of said first and second sensors generates said signal representing said cleanness according to a strength of light from said optical source.

20. The cleaning device according to claim 10, which further comprises a measuring unit including said first and second sensors and an optical-source-distributing section for equally distributing an optical source to said first and second sensors, wherein each of said first and second sensors generates said signal representing said cleanness according to a strength of light from said optical source.
